(19) United States
(12) Patent Application Publication
(10) Pub. No.: US 2019/0146626 A1
(43) Pub. Date: May 16, 2019

(54) INTEGRATION OF TOUCH AND SENSING

(71) Applicant: VueReal Inc., Waterloo (CA)

(72) Inventor: GHOLAMREZA CHAJI, Waterloo (CA)

(21) Appl. No.: 16/189,686

(22) Filed: Nov. 13, 2018

(30) Foreign Application Priority Data
Nov. 14, 2017 (CA) 2985264

(51) Int. Cl. G06F 3/041; G06F 3/044; G06F 3/047

(52) U.S. Cl. CPC G06F 3/0414; G06F 3/047; G06F 3/044

(57) ABSTRACT

The disclosure is related to provide an electrode associated with integration of the pixelated micro devices into a system substrate to make a touch electrode.

### CROSS-REFERENCE TO RELATED APPLICATION(S)

This application claims priority to Canadian Application No. 2,985,264, filed on Nov. 14, 2017, which is hereby incorporated by reference herein in its entirety.

### FIELD OF THE INVENTION

The present disclosure relates to an integration of touch and sensing into a micro device substrate.

### BRIEF SUMMARY

A few embodiments of this description are related to integration of touch and sensing into a substrate with integrated microdevices.

According to some examples, a micro device array is provided. The micro device array comprising at least a first conductive layer, wherein the at least first conductive layer is patterned to provide at least one touch electrode and a first micro device electrode that connects a micro device to a signal.

According to some examples, a method to fabricating a micro device array is provided. The method comprising forming a first conductive layer on a system substrate; and patterning the first conductive layer to provide at least one touch electrode and a first micro device electrode connecting a micro device to a signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other advantages of the disclosure will become apparent upon reading the following detailed description and upon reference to the drawings.

FIG. 1 shows an exemplary touch sensor electrode.

FIG. 2A shows an example of implementing touch electrode using micro device electrode.

FIG. 2B shows an example of using different micro device electrode to bridge the touch electrodes.

FIG. 3A shows another example of implementing touch electrode using micro device electrode.

FIG. 3B shows an example of connecting different pieces of micro device electrode to create larger touch electrode.

FIG. 3C shows another example of using different electrode of micro device to bridge the touch electrodes.

FIG. 4 shows an example of double electrode touch for multi functionality using microdevices electrodes.

FIG. 5 shows a system level implementation microdevice, touch, and multi functionality.

FIG. 6A shows an example where contacts pads of the micro device are facing the system substrate.

FIG. 6B shows an example where contacts pads of the micro device are facing away from the system substrate.

FIG. 7 demonstrates a pixel circuit.

The present disclosure is susceptible to various modifications and alternative forms, specific embodiments or implementations as have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

This disclosure is generally related to use an electrode associated with integration of the pixelated micro devices into a system substrate to make touch electrode.

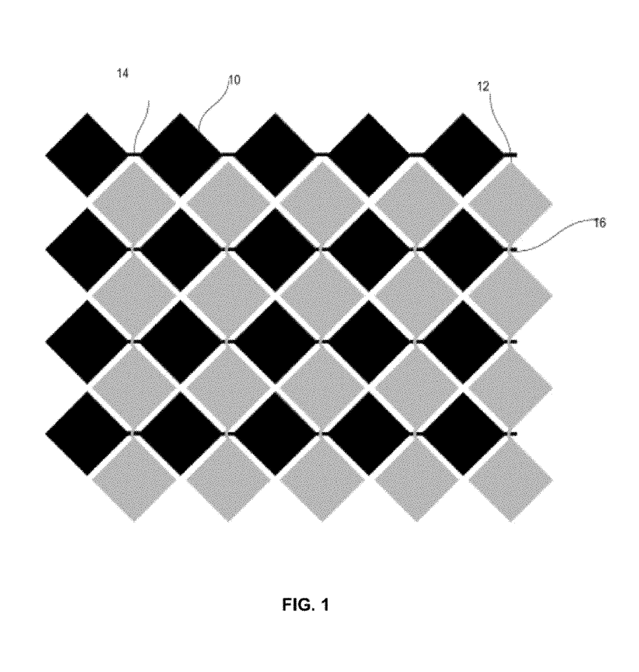

FIG. 1 shows an exemplary implementation of multi touch sensor. Here, a plurality of electrodes in a matrix form are patterned in two directions e.g. in x direction 10 and in y direction 12. If a same electrode is used to create the two directions, a bridge 14 can be used to connect pieces of the electrodes in x-direction and a bridge 16 can be used to connect pieces of the electrodes in y-direction. The capacitance of each electrode gets modulated by a touch e.g. either by a fingertip or other objects such as stylus. When the fingertip touches the patterning of X and Y electrodes, a capacitance coupling occurs between the finger and the electrodes. A change in the capacitance of the microdevice electrode is used to perform pressure sensing.

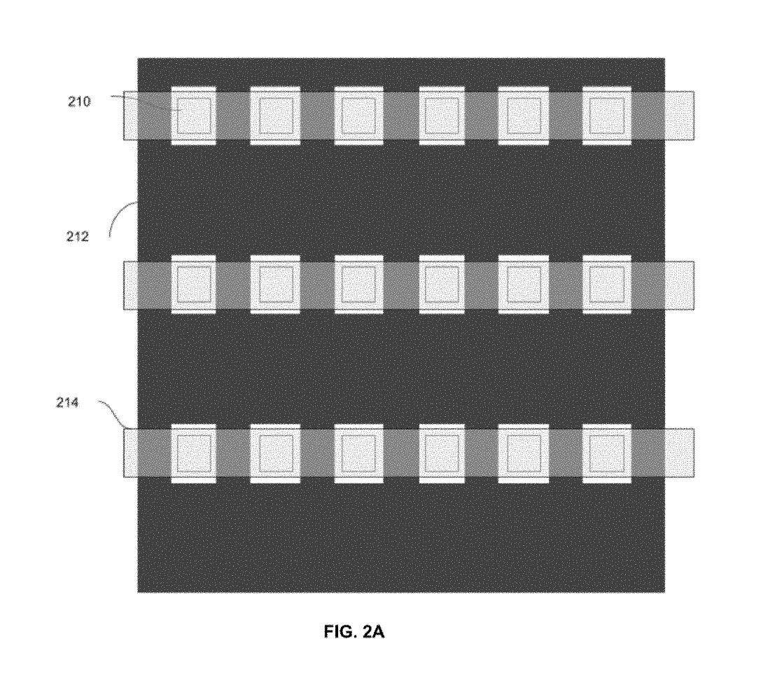

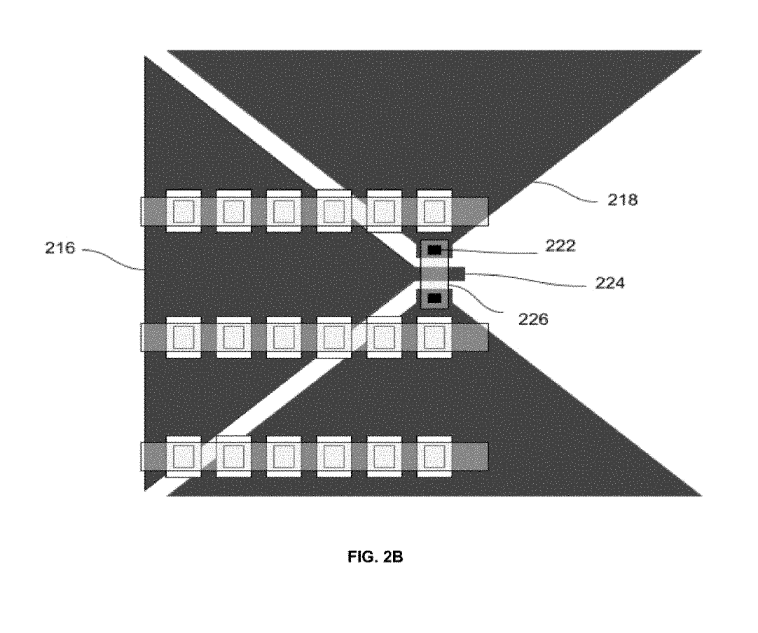

FIG. 2A shows an example of implementing touch electrode using micro device electrode. Here, a second conductive layer 212, e.g. a bottom conductive layer that can be used for integration of plurality of micro devices (a micro device 210 is shown as an example) into the backplane, is patterned to create a touch electrode. There can be a first conductive layer 214. The first conductive layer may be a top conductive layer. The first conductive layer can be one of: a first micro device electrode e.g. a top electrode from the substrate, another electrode of the micro device, or a different electrode. The first conductive layer 214 of the micro device is also patterned to keep some part of a second electrode 212 open. The second electrode may be a bottom electrode. This allows the second electrode 212 to have a direct sight to the surface without being electrically shielded by the first micro device electrode. In one embodiment, the second electrode 212 is one of an electrode used for electrical connection of the microdevice which is also patterned to create the touch electrode. The description may use one micro device to explain the disclosure, however, it may be easily extended to plurality of micro-devices. The first and second electrode can connect pad on an opposite surface of a micro device or at a same surface of the micro device.

FIG. 2B shows an embodiment of using the second electrode 212 to create the X 216 and Y 218 electrodes of the touch system. In one embodiment, the first electrode 214 of the micro device can be used to create a bridge 226 between different pieces of Y electrodes 218 (or X electrodes 216). Here, a top electrode piece 226 of the micro devices can be used to couple two pieces of the Y electrodes 218 (or X electrodes 216) through a plurality of vias/openings 222. The X electrodes (or Y electrodes) can also be connected directly through a piece of a bottom electrode 224. In another embodiment, another electrode acts as a bridge to connect different pieces of electrodes e.g. X electrodes 216.

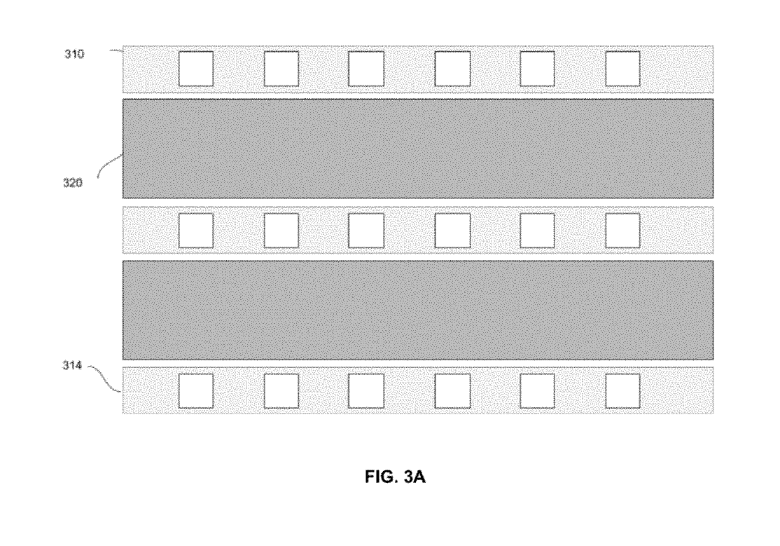

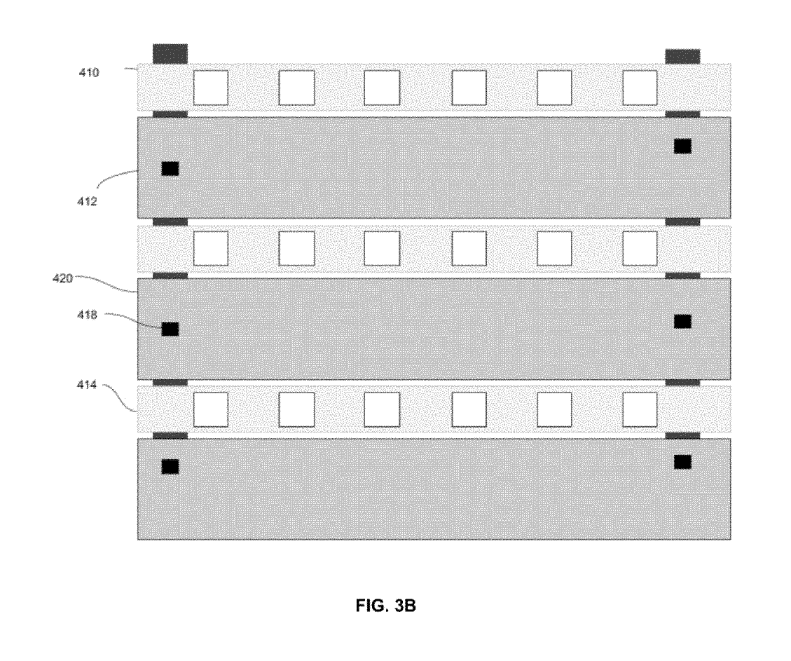

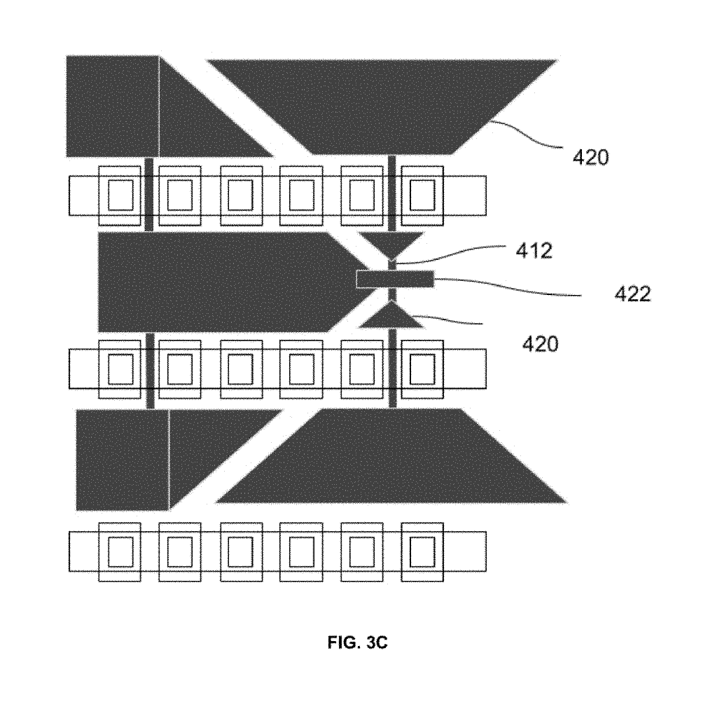

FIG. 3A shows another example of implementing touch electrode using micro device electrode. Here, the first electrode of micro devices (a micro device 310 is shown as an example) is designed into two types of strips; one stripe 314 connects the micro devices to a common signal (or power level) or a backplane element and the other stripe 320 creates touch electrodes. These touch strips 320 can be connected at the edge of the display to form wider touch electrodes.

FIG. 3B shows an example of connecting different pieces of micro device electrode to create a larger touch electrode. Here, shows an embodiment to provide connection between the strips of the first electrode. The first electrode of micro devices (a micro device 410 is shown as an example) is designed into two types of strips; one stripe 414 connects the micro devices to a common signal (or power level) or a backplane element, and the other stripe 420 creates touch electrodes. These strips are connected through another electrode such as bottom electrode of the micro devices using vias 418. Here, a first conductive layer 412 that is used for the micro device (410) integration into the backplane can also be patterned to create the touch electrode (420).

FIG. 3C shows another example of using different electrodes of micro device to bridge the touch electrodes. Here, shows a case where another conductive layer 412 is used as bridge to connect different pieces of electrodes e.g. Y electrodes 420. This conductive layer 412 can be one of: a top electrode from the substrate, another electrode of the micro device, or a different electrode. The other touch electrode can be connected through a bottom electrode 422.

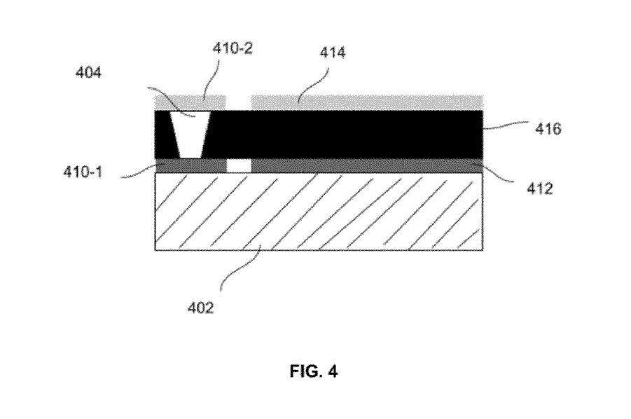

FIG. 4 shows an example of double electrode touch for multi functionality using microdevices electrodes. In one embodiment, a part 414 of one electrode 410-2 of the microdevice 404 can be used as a touch electrode and the part 412 of the other electrode 410-1 can be used as a pressure sensor. Here, this electrode can act as pressure sensor by itself or in combination with the other electrode 414. Here, the capacitor between the electrode 414 and 412 is modulated under the pressure. Here, a planarization layer or a filler layer 416 is used to separate the electrodes.

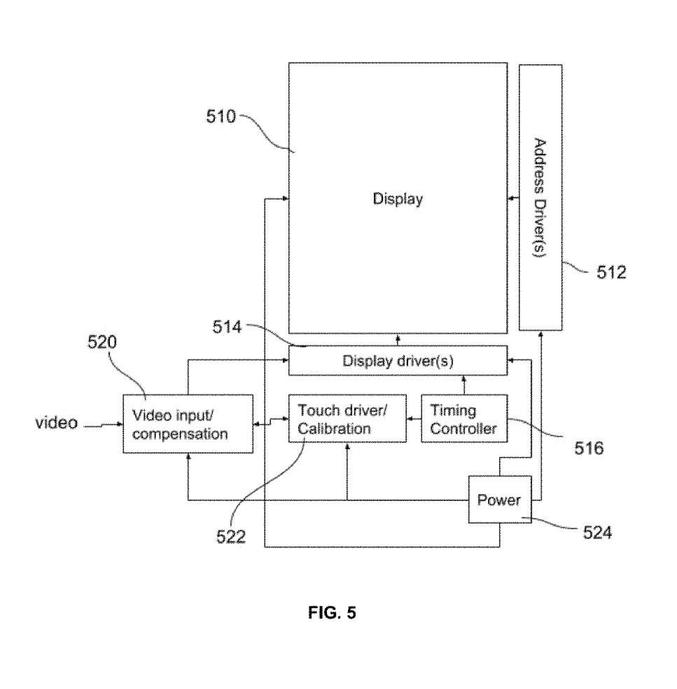

FIG. 5 shows a system level implementation of microdevice, touch, and multi functionality. Here, it shows an embodiment of a system substrate or display 510 with microdevice and integrated touch. The address driver 512 enables the display 510 row (or rows) for programming or calibration. The same address driver 512 can be used for controlling the touch sensor. Here, the timing controller 516 can control both display timing and the touch timing. The display driver 514 is used to program the pixels with the video data. The touch driver/calibration driver 522 can be also used as the calibration system for display. Here, the data from the video input program the calibration (touch driver) for extracting the information from the display 510. The power unit 524 provides power to the address drivers 512, display drivers 514, touch drivers 522, timing controller 516, video interface 520, and the display 510.

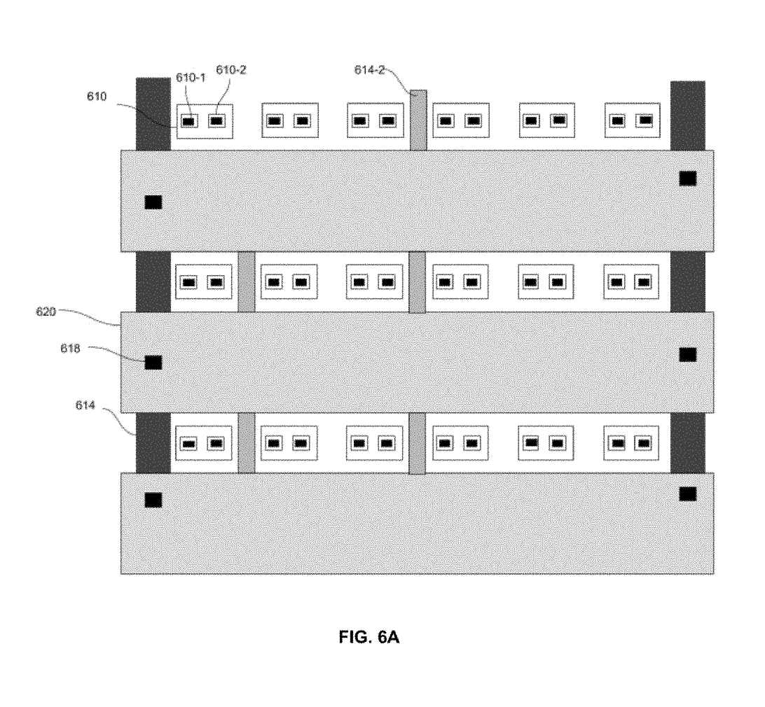

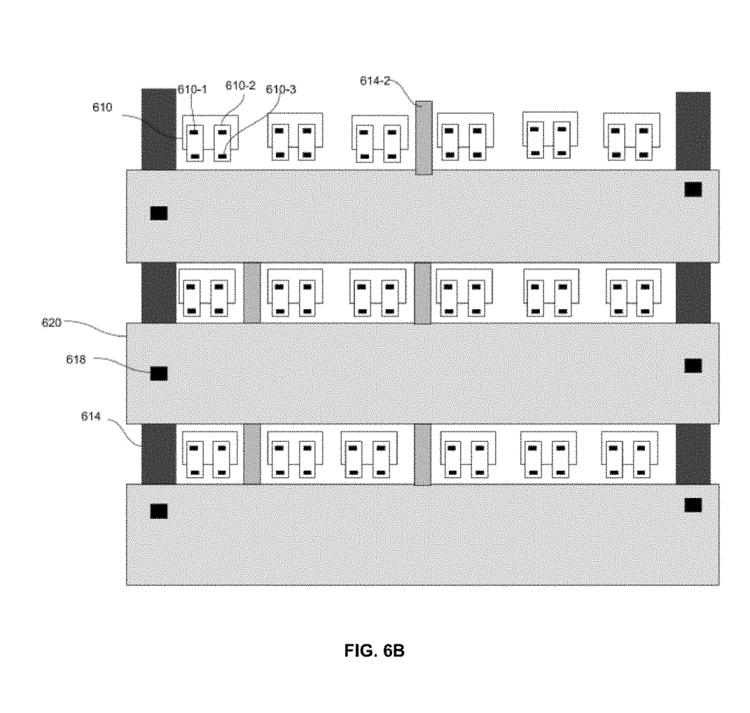

FIG. 6A demonstrates an embodiment wherein both contacts (pads) 610-1 (or more contacts) of micro device 610 are facing the display (system) substrate. In this case, an electrode on the display substrate is patterned to create pads e.g. 610-2 for connecting the micro device 610 to the display substrate. The same electrode can be also patterned to create the touch electrode 620. The pieces of the touch electrode 620 can be connected together through another conductive layer 614 using vias 618. The pieces of the electrodes 620 can also be connected together through traces 614-2 running between the micro devices 610.

FIG. 6B demonstrates an embodiment where both contacts 610-1 (or more contacts) of micro device 610 are facing away from the display (system) substrate. In this case, the electrode is deposited after the micro device integration into the system substrate (or display substrate) and patterned into traces 610-2 to cover the connections (pads or vias) 610-1, 610-3 on micro device and the substrate. The same electrode can be also patterned to create the touch electrode 620. The pieces of the touch electrode 620 can be connected together through another conductive layer 614 using vias 618. The pieces of the electrodes 620 can also be connected together through traces 614-2 running between the micro devices 610.

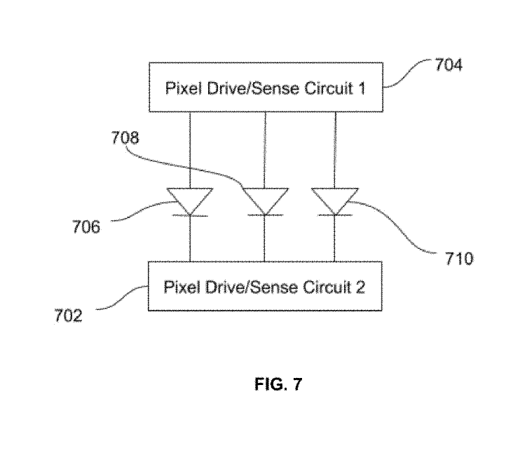

FIG. 7 demonstrates a pixel that its light emitting elements 706, 708, 710 can also detect different spectrum of lights. Here, light emitting element 706 emits in small visible wavelength (e.g. 420-500 nm) and absorbs wavelengths smaller than its emitting wavelength. The light emitting element 708 emits in mid-range visible wavelength (e.g. 500-580 nm) and absorbs wavelengths smaller than its emitting wavelength. The light emitting element 710 emits in long range visible wavelength (e.g. 600-700 nm) and absorbs wavelengths smaller than its emitting wavelength.

The micro devices in these embodiments can have different shape or orientation in respect to the substrate conductive traces.

According to some embodiments, a micro device array is provided. The micro device array comprising at least a first conductive layer, wherein the at least first conductive layer is patterned to provide at least one touch electrode and a first micro device electrode that connects a micro device to a signal.

According to another embodiment, the micro device further comprising a second conductive layer that connects at least two portions of each touch electrode. The second conductive layer is patterned to form a second micro device electrode different from the first micro device electrode.

According to yet another embodiment, the micro device array further comprising a pressure sensing electrode, different from the touch electrode, formed by patterning the second conductive layer and the touch electrode. A capacitor between the touch electrode and the pressure sensing electrode may be modulated under pressure.

According to another embodiment, one of the first conductive layer or second conductive layer may comprise one or more strips. The one strip provides the connection to the micro device array and another strip creates the at least one touch electrode. The one or more strips are connected through the second conductive layer. The one or more strips are connected at a edge of a display to form wider touch electrodes.

According to further embodiments, a planarization layer is disposed to separate the first and second conductive layers.

According to some examples, a method to fabricating a micro device array is provided. The method comprising forming a first conductive layer on a system substrate; and patterning the first conductive layer to provide at least one touch electrode and a first micro device electrode connecting a micro device to a signal.

According to another embodiment, the method may further be comprising forming a second conductive layer, on the system substrate, that connects at least two portions of each touch electrode. The second conductive layer may be patterned to form a second micro device electrode different from the first micro device electrode.

According to further embodiments, a pressure sensing electrode, different from the touch electrode, may formed by patterning the second conductive layer and the touch electrode.

According to further embodiments, a planarization layer may be formed to separate the first and second conductive layers.

The invention being thus described, it will be obvious that the same may be varied in many ways. Such variations are not to be regarded as a departure from the scope of the invention, and all such modifications as would be obvious to one skilled in the art are intended to be included within the scope of the following claims.

We claim:

1. A micro device array comprising:
at least a first conductive layer, wherein the at least first conductive layer is patterned to provide at least one touch electrode and a first micro device electrode that connects a micro device to a signal.

2. The micro device array of claim 1, further comprising:
a second conductive layer that connects at least two portions of each touch electrode.

3. The micro device array of claim 1, wherein the second conductive layer is patterned to form a second micro device electrode different from the first micro device electrode.

4. The micro device array of claim 1, further comprising:
a pressure sensing electrode, different from the touch electrode, formed by patterning the second conductive layer and the touch electrode.

5. The micro device array of claim 1, wherein a capacitor between the touch electrode and the pressure sensing electrode is modulated under pressure.

6. The micro device array of claim 1, wherein one of the: first conductive layer or second conductive layer comprises one or more strips.

7. The micro device array of claim 7, wherein the one strip provides the connection to the micro device array and another strip creates the at least one touch electrode.

8. The micro device array of claim 7, wherein the one or more strips are connected through the second conductive layer.

9. The micro device array of claim 7, wherein the one or more strips are connected at an edge of a display to form wider touch electrodes.

10. The micro device array of claim 1, wherein a planarization layer is disposed to separate the first and second conductive layers.

11. A method to fabricating a micro device array, the method comprising:
forming a first conductive layer on a system substrate; and
patterning the first conductive layer to provide at least one touch electrode and a first micro device electrode that connects a micro device to a signal.

12. The method of claim 11, further comprising:
forming a second conductive layer, on the system substrate, that connects at least two portions of each touch electrode.

13. The method of claim 12, wherein the second conductive layer is patterned to form a second micro device electrode different from the first micro device electrode.

14. The method of claim 12, further comprising:
a pressure sensing electrode, different from the touch electrode, formed by patterning the second conductive layer and the touch electrode.

15. The method of claim 12, further comprising:
forming a passivation layer between the first conductive layer and the second conductive layer.
